(19) United States
(12) Patent Application Publication
(10) Pub. No.: US 2026/0213225 A1
(43) Pub. Date: Jul. 23, 2026

(54) SOLID OXIDE FUEL CELL AND METHOD FOR MANUFACTURING THE SAME

(71) Applicant: KOREA INSTITUTE OF ENERGY RESEARCH, Daejeon (KR)

(72) Inventors: Jong Eun HONG, Daejeon (KR); Rak Hyun SONG, Seoul (KR); Seok Joo PARK, Daejeon (KR); Seung Bok LEE, Daejeon (KR); Hye Sung KIM, Daejeon (KR); Dong Woo JOH, Sejong Special Self-Governing City (KR); Tak Hyoung LIM, Daejeon (KR)

(73) Assignee: KOREA INSTITUTE OF ENERGY RESEARCH, Daejeon (KR)

(21) Appl. No.: 18/880,119

(22) PCT Filed: Sep. 7, 2023
(86) PCT No.: PCT/KR2023/013387

§ 371 Date: Sep. 19, 2025

(30) Foreign Application Priority Data
Sep. 7, 2022 (KR) 10-2022-0113174

(51) Int. Cl. H01M 4/90; H01M 4/86; H01M 4/88; H01M 8/12; H01M 8/1213

(52) U.S. Cl. CPC H01M 4/9033; H01M 4/8825; H01M 4/8885; H01M 8/1213; H01M 2004/8689; H01M 2008/1293

(57) ABSTRACT

The present invention relates to a solid oxide fuel cell and to a method for manufacturing same, wherein the solid oxide fuel cell is obtained by forming an NBCC (NdBa0.75Ca0.25C0205+8) double perovskite oxide,
which has excellent mixed conductivity and a higher surface exchange co-efficient compared to a commercial perovskite air electrode, on a commercial air electrode by using an ultrasonic spray penetration method.

### TECHNICAL FIELD

The present invention relates to a solid oxide fuel cell and a method for manufacturing the same. Specifically, various embodiments of the present invention relate to a solid oxide fuel cell including an air electrode in which layered double Perovskite nanoparticles are formed by an ultrasonic spray infiltration process, and a method for manufacturing the solid oxide fuel cell.

### BACKGROUND ART

Recently, due to the increase in global consumption of fossil fuels, the amount of carbon dioxide emissions into the atmosphere has increased. This has caused climate change and environmental destruction, and in order to solve this problem, research on renewable energy sources along with carbon dioxide reduction has been widely conducted. To date, geothermal energy, wind energy, sunlight, solar thermal energy, hydrogen energy, and the like are considered as energy sources to replace fossil energy. Among the above, hydrogen is currently attracting the most attention among alternative energy sources due to the advantages that the hydrogen can be easily produced through the electrolysis of water and that water is readily available as the water occupies 66% or more of the earth's surface.

A fuel cell is a device that generates electrical energy by electrochemically reacting a fuel and an oxidant, and is attracting attention as a next-generation energy source due to a high power generation efficiency with no environmental pollution problems, and it can be said that the fuel cell is an essential means as an alternative energy source capable of overcoming environmental and energy problems we currently face, such as the continuous depletion of energy resources that are not infinite.

On the other hand, a solid oxide fuel cell (SOFC), which is representative among various fuel cells, has a higher power generation efficiency than other fuel cells, and can use not only hydrogen but also hydrocarbon fuels such as carbon monoxide (CO), methane (CH₄), and propane (C₃H₈), thereby allowing freedom in fuel selection and enabling combined heat and power generation, but has a high operating temperature, so that the cell itself has a high deterioration rate and requires the use of expensive components, which is disadvantageous.

Therefore, in recent years, in order to overcome the problems caused by the high-temperature operation of an SOFC, research has been actively conducted to reduce the operating temperature to a mid-low temperature region (500° C. to 700° C.) through the formation of electrolyte thin films, the development of new electrode materials, and the improvement in cell design.

In order to prevent phase transformation, microstructure change, or delamination due to differences in thermal expansion coefficients during high-temperature operation, an air electrode constituting an SOFC is required to have a coefficient of thermal expansion similar to those of neighboring components and be chemically and structurally stable. In addition, the air electrode is required to have high electronic and ionic conductivity to facilitate the flow of charges. In addition, the air electrode is required to have a sufficiently porous structure to facilitate the diffusion of an oxygen gas.

Considering that an oxygen reduction reaction of the air electrode is a rate-determining step of an SOFC reaction, it is obvious that the performance of a mixed conductive material used as the air electrode is an important factor in determining the overall reaction rate of the SOFC and has a great influence on the performance of the cell. Therefore, it can be said that research on air electrode materials is essential to improve the performance of cells. Recently, research has been conducted on a layered double Perovskite material having a AA′B₂O_{5+δ} structure as a next-generation intermediate temperature (500° C. to 700° C.) SOFC air electrode material.

### DISCLOSURE OF THE INVENTION

### Technical Problem

An object of the present invention is to provide a solid oxide fuel cell in which NdBa_{0.75}Ca_{0.25}Co₂O_{5+δ}. (NBCC) layered double Perovskite, which has a high surface exchange coefficient and excellent mixed conductivity compared to a commercially available perovskite air electrode, is formed on a commercially available air electrode by using an ultrasonic spray infiltration method, and a method for manufacturing the solid oxide fuel cell.

### Technical Solution

A solid oxide fuel cell according to various embodiments of the present invention includes an anode support, an anode functional layer disposed in an upper portion of the anode support, an electrolyte layer disposed in an upper portion of the anode functional layer, a buffer layer disposed in an upper portion of the electrolyte layer, a porous air electrode disposed in an upper portion of the buffer layer, and a metal thin film layer disposed in an upper portion of the porous air electrode are stacked, wherein the porous air electrode is composed of a LSCF(La0.6Sr0.4Co0.2Fe0.803)-GDC(Ce0.9Gd0.1O2)composite, and includes layered double Perovskite nanoparticles prepared on the the LSCF-GDC electrode surface.

A method for manufacturing a solid oxide fuel cell according to various embodiments of the present invention includes forming an anode support, an anode functional layer, an electrolyte, and a buffer layer, forming an air electrode on the buffer layer, preparing an infiltration solution containing layered double Perovskite composition, ultrasonic spraying the infiltration solution onto the air electrode, and calcining the air electrode infiltrated by the infiltration solution in the ultrasonic spraying step.

### Effects of the Invention

The present invention forms a NdBa_{0.75}Ca_{0.25}Co₂₅. (NBCC) layered double Perovskite oxide, which has a high surface exchange coefficient and excellent mixed conductivity compared to a commercially available perovskite air electrode, on a commercially available air electrode by using an ultrasonic spray infiltration method.

An NBCC infiltration solution prepared by adding citric acid and EDTA is capable of forming a single phase even at a low calcination temperature of 950° C. In addition, NBCC particles formed by an ultrasonic spray infiltration process may be uniformly formed to a size of 10 nm to 20 nm on the surface of an LSCF-GDC commercially available air electrode.

In addition, results of impedance analysis on an electrode half-cell have confirmed that nano-sized NBCC infiltration particles are capable of reducing polarization resistance by increasing a triple phase boundary required for an electrode reaction in an air electrode, thereby enhancing an oxygen reduction reaction in which an adsorbed oxygen ion intermediate (O⁻) moves to the triple phase boundary.

Compared to a case in which a commercially available air electrode is applied, a single cell using an air electrode to which the NBCC infiltration particles of the present invention are applied is capable of showing a result of improving the maximum power density by an average of 88.5%, and results of long-term performance measurement have confirmed that the NBCC infiltration particles have good long-term stability.

### BRIEF DESCRIPTION OF THE DRAWINGS

FIG. 1 shows XRD analysis results after performing heat-treatment on NBCC powder synthesized using urea chelate.

FIG. 2 shows XRD analysis results after performing heat-treatment on NBCC powder prepared using an infiltration solution containing glycine as a chelating reagent.

FIG. 3 shows XRD analysis results after performing heat-treatment on NBCC powder prepared using an infiltration solution prepared by adding citric acid and EDTA.

FIG. 4 shows the microstructure of an LSCF-GDC commercially available air electrode heat-treated at 1100° C.

FIG. 5 shows the microstructure of a cross-section of an LSCF-GDC air electrode after allowing an NBCC precursor solution to infiltrate thereinto by an ultrasonic spray process and then calcining the same at 950° C. for 2 hours.

FIG. 6 is a STEM image of a commercially available LSCF-GDC air electrode infiltrated by NBCC.

FIG. 7(a) and FIG. 7(b) respectively show results of High-Angle Annular Dark Field Scanning Transmission Electron Microscopy (HAADF-STEM) analysis on (110) and (001) planes.

FIG. 8 shows the Nyquist plot of an LSCF-GDC air electrode infiltrated by NBCC and a commercially available LSCF-GDC air electrode, which are measured in an air atmosphere at 700° C. and a flow rate of 200 ml/min.

FIG. 9 is a graph obtained by converting the area specific resistance of a commercially available LSCF-GDC air electrode and an LSCF-GDC air electrode infiltrated by NBCC into the reciprocal relationship between a natural log and a temperature.

FIG. 10 shows the Nyquist plot and Bode plot after measuring impedance while changing the oxygen partial pressure to 0.21, 0.15, 0.1, and 0.05 atm with respect to a half-cell including a commercially available LSCF-GDC air electrode.

FIG. 11 shows the Nyquist plot and Bode plot after measuring impedance while changing an oxygen partial pressure to 0.21, 0.15, 0.1, and 0.05 atm with respect to a half-cell including a commercially available LSCF-GDC air electrode infiltrated by NBCC.

FIG. 12 shows the result of processing the impedance measurement data using the distribution of relaxation time (DRT) analysis method, in which changes in resistance with respect to frequency are converted into the time domain. Based on these transformed data, it then presents the result of analyzing the data with an equivalent circuit structure composed of three elements: R_{electrolyte}, R₁-CPE₁, and R₂-CPE₂.

FIG. 13 shows the relationship of area specific resistance to an oxygen partial pressure taken as a natural log measured at 700° C.

FIG. 14 shows XPS measurement results to compare the surface oxidation state between an LSCF-GDC air electrode and an air electrode infiltrated by NBCC.

FIG. 15 shows comparison results of the performance measured at 700° C. between a single cell manufactured by coating an LSCF-GDC air electrode on the surface of an electrolyte formed on an anode support and sintering the same at 1100° C. and a single cell manufactured by allowing an NBCC precursor solution to infiltrate into the corresponding air electrode by an ultrasonic spraying process and then calcining the same at 950° C. for 2 hours.

FIG. 16 shows comparison results of the maximum power density between the two single cells according to an operating temperature.

FIG. 17 shows impedance Nyquist plots of a single cell using a commercially available LSCF-GDC air electrode and a single cell applied with an air electrode infiltrated by NBCC measured at 700° C. and an open circuit voltage, and an equivalent circuit used to analyze the impedance Nyquist plots.

FIG. 18 shows comparison results of the ohmic resistance between the two single cells according to an operating temperature. FIG. 20(b) shows analysis results obtained by dividing polarization resistance into R1, R2, and R3 according to the equivalent circuit.

FIG. 19 shows results of fitting the impedance measurement result for a single cell by using a distribution relaxation time (DRT) method.

FIG. 20 shows the voltage change over time of a commercially available LSCF-GDC air electrode and an LSCF-GDC air electrode infiltrated by NBCC.

### MODE FOR CARRYING OUT THE INVENTION

Hereinafter, various embodiments of the present disclosure are described with reference to the accompanying drawing. The embodiments and terms used herein are not intended to limit the technical features described in the present disclosure, but should be understood to include various modifications, equivalents, and/or alternatives of the corresponding embodiments.

The present invention provides a solid oxide fuel cell in which NdBa_{0.75}Ca_{0.25}Co₂O_{5+δ} (NBCC) layered double Perovskite, which has a high surface exchange coefficient and excellent mixed conductivity compared to a commercially available perovskite air electrode, is formed on a commercially available air electrode by using an ultrasonic spray infiltration method, and a method for manufacturing the solid oxide fuel cell.

Specifically, the solid oxide fuel cell according to various embodiments of the present invention has a structure in which an anode support, an anode functional layer disposed in an upper portion of the anode support, an electrolyte layer disposed in an upper portion of the anode functional layer, a buffer layer disposed in an upper portion of the electrolyte layer, a porous air electrode disposed in an upper portion of the buffer layer, and a metal thin film layer disposed in an upper portion of the porous air electrode are stacked.

The anode support is a flow path of a fuel gas in a fuel cell module, and serves as a support for coating an anode. The anode is required to have a porous structure to allow electrons generated from a fuel oxidation reaction to reach a current collector and to facilitate the diffusion and reaction of a fuel, and is required to have high electronic conductivity and ionic conductivity. The anode support may include a NiO-YSZ composite material, which is a mixture of a metal and ceramic, such as nickel oxide (NiO) and yttria stabilized zirconia (YSZ).

In order to increase the area of a triple phase boundary in which a reaction occurs in the anode, the anode functional layer having smaller particles may be coated on the surface of the anode support to make an electrochemical reaction more active. The anode functional layer may contain NiO-YSZ, which is the same component as that of the anode support, or may contain NiO-ScCeSZ.

The electrolyte layer may be positioned on the anode functional layer. The electrolyte layer is positioned between the anode functional layer and the air electrode, and conducts oxygen ions between the anode and the air electrode. The electrolyte layer requires high oxygen ionic conductivity, and is required to be dense to prevent cross-diffusion of a fuel and oxygen. For example, the electrolyte layer may include any one selected from the group consisting of 8 mol % Y₂O₃ stabilized ZrO₂(8YSZ), Sc₂O₃ stabilized ZrO₂(ScSZ), gadolinium-doped ceria (GDC), lanthanum strontium magnesium gallate (LSGM), and ScCeSZ in which 1 mol % ceria is substituted into ScSZ.

The buffer layer is positioned between the electrolyte layer and the porous air electrolyte, and may contain gd-doped ceria (GDC).

The porous air electrode may be disposed on the buffer layer. In the air electrode, an oxygen reduction reaction in which oxygen molecules are reduced to oxygen ions occurs. In the oxygen reduction reaction, oxygen adsorbed on the surface of the air electrode is dissociated, is subjected to surface diffusion, and moves to a triple phase boundary (TPB) at which an electrode, an electrolyte, and a reaction gas all meet, is reduced to oxygen ion by obtaining an electron, and then moves to an anode through the electrode.

Therefore, since the oxygen reduction reaction mainly occurs at the triple phase boundary, a material which exhibits both electronic and ionic conductivity is advantageous in improving electrode performance. For this reason, in recent years, a material having mixed conductivity (mixed ionic and electronic conductor (MIEC)) has been widely used as an air electrode material.

The porous air electrode of the present invention may include at least one among La₁₋ₓSrₓCo_{1-y}Fe_{y}O_{3-d} (LSCF), La₁₋ₓSrₓMnO_{3-d} (LSM), La₁₋ₓSrₓCoO_{3-d} (LSC), and LaNi_{1-y}Fe_{y}O_{3-d} (LNF). Here, 0<x<1, 0<y<1, 0≤d<3. The porous air electrode of the present invention may be a composite of any one of LSCF, LSM, LSC and LNF, and GDC.

For example, the porous air electrode of the present invention may be composed of a La_{0.6}Sr_{0.4}Co_{0.2}Fe_{0.8}O₃(LSCF)-Ce_{0.9}Gd_{0.1}O₂(GDC) composite. In this case, layered double Perovskite nanoparticles may be included on the LSCF-GDC.

The performance of a mixed conductive material used as the air electrode is an important factor in determining the overall reaction rate of the SOFC and has a great influence on the performance of the cell. In the present invention, as the mixed conductive material, a single-phase layered double Perovskite is introduced, so that the cell performance may be improved. Particularly, the layered double Perovskite is NdBa_{0.75}Ca_{0.25}Co₂O_{5+δ} (NBCC). NBCC has a high surface exchange coefficient and excellent mixed conductivity compared to a commercially available perovskite air electrode.

Layered double Perovskite nanoparticles are uniformly formed on the surface of the air electrode, and may have a diameter of 10 nm to 20 nm.

The metal thin film layer is preferably made of a metal selected from the group consisting of Ag, Pt, Au, Cu, Co, Ni, and Mn, and is more preferably a Pt thin film layer.

Meanwhile, it has been described that the layered double Perovskite nanoparticles of the present invention are used for an air electrode of a solid oxide fuel cell, but the embodiment is not limited thereto, and the nanoparticles may be applied to electrodes of various cells, such as an oxygen electrode of a solid oxide electrolysis cell (SOEC), an air electrode of a protonic ceramic fuel cell (PCFC), an oxygen electrode of a protonic ceramic electrolysis cell (PCEC), and electrodes of a high temperature co-electrolysis and CO₂ electrolysis cells.

Hereinafter, a method for manufacturing a solid oxide fuel cell according to various embodiments of the present invention will be described.

The method for manufacturing a solid oxide fuel cell of the present invention may include forming an anode support, an anode functional layer, an electrolyte, and a buffer layer, forming an air electrode on the buffer layer, preparing an infiltration solution containing layered double Perovskite, ultrasonic spraying the infiltration solution onto the air electrode, and calcining the air electrode infiltrated by the infiltration solution in the ultrasonic spraying step.

In the step of forming an anode support, an anode functional layer, an electrolyte, and a buffer layer, the anode support, the anode functional layer, the electrolyte, and the buffer layer may be formed by coating each precursor solution. The coating may be performed by at least one process selected from the group consisting of tape casting, lamination, screen printing, spray coating, and slurry dip coating.

In the step of forming an air electrode, the air electrode may be manufactured by screen-printing an ink including an air electrode precursor on the buffer layer, followed by sintering the screen-printed layer.

Next, in the step of preparing an infiltration solution containing layered double Perovskite, the infiltration solution may be prepared by including the layered double Perovskite and an additive (chelating agent). In this case, the additive may include citric acid. In addition, the additive may include ethylenediaminetetraacetic acid (EDTA) in addition to the citric acid. By using such an additive, it is possible to prepare a single-phase layered double Perovskite without a secondary phase.

On the other hand, citric acid may be added in molar a ratio of cations:citric acid=2:1. In addition, EDTA may be added in the same molar ratio as citric acid.

Next, the step of ultrasonic spraying the infiltration solution onto the air electrode may be performed. That is, in the present invention, layered double Perovskite nanoparticles may be formed by an ultrasonic spray infiltration process. For example, the infiltration solution may be sprayed onto the air electrode by using ultrasonic spraying at a rate of 2 μl/min to 4 μl/min and at a frequency of 80 kHz to 90 kHz, and then dried. In addition, the infiltration process may be repeated multiple times.

The solution having a composition with excellent oxygen reduction reaction properties is infiltrated into the surface of the already formed air electrode, and then heat-treated at a temperature lower than an electrode manufacturing temperature to form fine particles or a coating layer, so that it is possible to expand a triple phase boundary region to improve the performance of the air electrode. Therefore, the solution used for the infiltration method is required to form a single phase having a desired composition even at a relatively low heat treatment temperature.

On the other hand, an ultrasonic spray process using an ultrasonic generator helps to form fine droplets to form more uniform and smaller particles. For example, a vibrator of an ultrasonic nozzle moves by converting a frequency set by a vibrate generator into mechanical vibration, and high vibration energy generated at this time creates a surface tension in a spray solution constantly supplied to a tip of the ultrasonic nozzle. Thereafter, while the amplitude of a generated surface tension wave is maintained constant, droplets of a uniform size are separated from the solution, and as the frequency increases, smaller droplets may be formed.

Therefore, in the present invention, by using the ultrasonic spraying process in the infiltration method, it is possible to spray fine droplets while supplying a small amount of an infiltration solution, thereby suppressing over-coating, and enabling effective and uniform infiltration into an air electrode having small pores. In addition, a spray device may be automated for application to large-area electrodes or mass production processes.

Next, in the calcining step, the air electrode infiltrated by the infiltration solution in the ultrasonic spraying step may be calcined. In this case, the calcining step may be performed at 900° C. to 1000° C. The present invention may form a single-phase layered double Perovskite even at such a low calcination temperature.

Hereinafter, the present invention will be described in more detail through examples and experimental examples.

These examples and experimental examples are only intended to illustrate the present invention in more detail, and it is obvious to those skilled in the art that the scope of the present invention is not limited by these examples and experimental examples according to the gist of the present invention.

### <Example 1> Synthesis of NaBa_{0.75}Ca_{0.25}C₂O_{5+δ} (NBCC) Powder

An NBCC solution to be infiltrated into an air electrode is prepared as follows. First, as precursors, Nd nitrate hexahydrate {Nd(NO₃)₃6H₂O, 99.9%, Sigma-Aldrich}, barium nitrate {Ba(NO₃)₂, 99%, Sigma-Aldrich}, calcium nitrate tetrahydrate {Ca(NO₃)₂4H₂O, 99%, Sigma-Aldrich}, cobalt nitrate hexahydrate {Co(NO₃)₂6H₂O, 98.5%, Sigma-Aldrich} are dissolved in distilled water to prepare a 0.1 M NBCC precursor solution. Thereafter, for uniform mixing of the precursor ions, various chelates are added to prepare an infiltration solution.

### <Example 2> Preparation of Infiltration Solution Using Urea

A solution in which urea (CH₄N₂O, 99.9%, Sigma-Aldrich) is added at a molar ratio of cations:urea=1:10 is prepared. The solution added with the urea is completely dried at 80° C., and then precipitates are heated at 300° C. or higher to remove organic substances, and calcined at 800° C. to 1000° C. for 2 hours.

### <Example 3> Preparation Infiltration Solution Using Glycine

A solution in which glycine (C₂H₅NO₂, 98.5%, Sigma-Aldrich) is added at a molar ratio of cations:glycine=1:1 is prepared. The solution is dried at 120° C., and then ash burned at 300° C. or higher is crushed and calcined at 800° C. to 1000° C. for 2 hours.

### <Example 4> Preparation of Infiltration Solution Using Citric Acid and EDTA

Citric acid (C₆H₈O₇, 99.9%, Sigma-Aldrich) and ethylenediaminetetraacetic acid (EDTA, C₁₀H₁₆N₂O₈99.9%, SAMCHUN) are used as chelating reagents. First, citric acid is added at a molar ratio of cations:citric acid=2:1. Thereafter, EDTA is slowly added at the same molar ratio as the citric acid while being stirred to be dissolved in an ammonia solution (NH₄OH; H₅NO, 28.5% Junsei) solvent to prepare an EDTA solution. Thereafter, the EDTA solution is slowly added to an NBCC solution added with citric acid. Finally, an ammonia solution is added to the NBCC solution containing EDTA and the mixture is stirred for 24 hours while adjusting the pH of the solution up to 6.

Thereafter, the solvent is evaporated at 120° C., and then solution is gelled. Gelled precursors are heated to 300° C. or higher to remove organic substances, and then calcined at 800° C. to 1000° C. for 2 hours to prepare powder.

### <Example 4> Manufacturing of Half-Cell and Anode-Supported SOFC

For the manufacture of a half-cell, Gd_{0.1}Ce_{0.9}O_{2-δ} (GDC) powder of the Fuel Cell Material (FCM) company is used to manufacture a GDC pellet using a circular mold having a diameter of 15 mm. The pellet is uniaxially pressed and molded under a pressure of 30 MPa and then sintered at 1500° C. for 10 hours. The sintered pellet is surface-polished with SiC paper having 1500 grits and then coated by screen-printing 50 wt. % LSCF-GDC mixed air electrode ink in a square shape having a size of 7×7 mm. An electrode is sintered at 1100° C. for 2 hours. Thereafter, the entire surface of a counter electrode is coated with Pt paste (Tanaka Co.) by using a brush and sintered at 800° C. for 2 hours. An NBCC precursor solution is sprayed onto an LSCF-GDC electrode by using ultrasonic spraying at a frequency of 85 kHz and a rate of 3 μl/min, and then dried. The infiltration process is repeated 7 times and then the electrode is calcined at 950° C. for 2 hours.

An anode-supported SOFC single cell is manufactured by co-sintering a green sheet, in which |NiO-YSZ| |NiO-ScCeSZ| |ScCeSZ| and |GDC| are tape-cast and laminated in that order, to manufacture a half-cell, and then coating the half-cell by screen-printing LSCF-GDC ink in a square shape of 7×7 mm thereon, and then calcining the half-cell at 1100° C. for 2 hours. As in the case of the half-cell, an NBCC precursor solution is sprayed by using ultrasonic spraying at a frequency of 85 kHz and a rate of 3 μl/min, and then dried. The infiltration process is repeated 7 times and then the half-cell is calcined at 950° C. for 2 hours.

### Experimental Examples

### Experimental Methods

### (1) Measurement of Area Specific Resistance of Electrode

In order to measure the area specific resistance (ASR) of an electrode, a current collector made of Ag mesh and wire is collected on an air electrode and a counter electrode of the previously manufactured half-cell by using CCC-LTS paste of Kceracell company. In a thickness portion of a GDC pellet, a reference electrode is manufactured using Pt wire and paste. The area specific resistance of a half-cell is measured by a three-electrode method from 750° C. to 600° C. using Biologic SP240. In addition, the impedance of the air electrode is measured by changing an oxygen partial pressure condition to 0.21, 0.15, 0.1, and 0.05 atm.

The current collection of an anode of a single cell is performed using a Ag current collector and Ni paste of FCM company. In order to separate the anode of the single cell, in which the current collection has been completed, and an air electrode thereof, the single cell is placed on an evaluation device prepared as an alumina tube, and a peripheral portion of the single cell is fixed and sealed using alumina bond (P-24, TOKU CERAMIC). The evaluation device attached with the alumina bond is subjected to a drying process at a temperature of lower than 70° C. for about 1 hour, and then subjected to a curing process performed at a temperature of 150° C. or higher for 1 hour and 30 minutes or more. The performance measurement of the single cell is measured by a 4-point probe method, and the impedance analysis is measured using AC impedance. Prior to measurement, with a fixed total flow rate of 100 ml/min, a mixture of hydrogen and nitrogen is supplied to the anode at 750° C. to reduce the anode. Purging is performed for 20 minutes initially with nitrogen of 100 ml/min, and then the mixture is changed to hydrogen of 20 ml/min and nitrogen of 80 ml/min, followed by increasing hydrogen by 20 ml/min for every 1-hour interval to hydrogen of 100 ml/min, thereby supplying air to the air electrode under the condition of 200 ml/min. The performance evaluation of the single cell is performed in an atmosphere with a flow rate of 100 ml/min of hydrogen to the anode and 200 ml/min of air to the air electrode at a temperature of 750° C. to 600° C. The impedance measurement results are obtained by converting the relationship of resistance according to a frequency into a function of time by using a distribution of relaxation time (DRT) method, thereby specifically dividing, fitting, and analyzing each reaction step occurring in the single cell. In order to evaluate long-term stability of the single cell, a current density at which the voltage of the single cell is 0.8 V is applied at the same gas flow rate at 700° C.

### (2) Analysis of Physicochemical Properties of Air Electrode

The layered double Perovskite material described above tends to have difficulty in forming a single phase at a low calcination temperature. In addition, in order to be present as fine particles in the air electrode, the layered double Perovskite material is required to be calcined at a low temperature, and thus, is required to be heat-treated in a low-temperature region. Therefore, in this experiment, it is important to secure a layered double Perovskite precursor solution having a single phase even at a low calcination temperature. Therefore, powder prepared with solutions containing each chelating reagent was calcined at 800° C. to 1000° C., and then measured with X-ray diffractometer (XRD, D-max-2500, Cu Kα, Rigaku) in the range of 2θ=10° to 90° to analyze the formation of an NBCC layered double Perovskite single phase. Then, in order to confirm the state of oxidation of the surface of the air electrode after NBCC infiltration, X-ray photoelectron spectroscopy (XPS, K-Alpha+, ThermoFisher Scientific) analysis was performed.

### (3) Analysis of Microstructure of Air Electrode

The microstructure of the air electrode ultrasonically sprayed with the NBCC precursor solution and heat-treated was analyzed using a field emission scanning electron microscope (FE-SEM, NovaNano SEM 450, FEI), and in order to confirm the crystal structure so as to determine whether actual infiltration particles were NBCC particles, the air electrode infiltrated by the particles was prepared into a scanning transmission electron microscopy (STEM) analysis sample having a size of 5×5 μm by using a focused ion beam (FIB, Helios 450 F1, FEI). Thereafter, the lattice constant of the infiltration particles was analyzed through high-angle annular dark field (HAADF)-STEM (Themis Z, FEI) measurement, and composition analysis was performed through energy dispersive X-ray spectroscopy (STEM-EDS) measurement to confirm whether the single phase was formed or not.

### Experimental Results

### (1) XRD Analysis Results

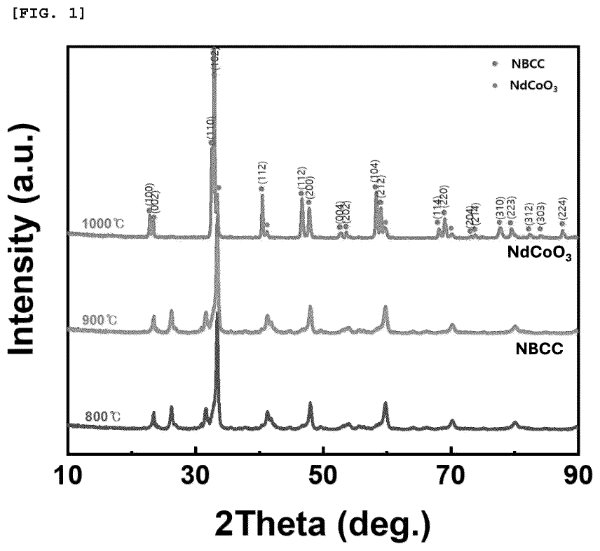

FIG. 1 shows XRD analysis results after performing heat-treatment on NBCC powder synthesized using urea chelate. From the measurement results obtained after calcining the powder from 800° C. to 1000° C., it has been confirmed that the sample in which NBCC is present as a main peak is the case in which the heat-treatment was performed at 900° C. or higher. Thereafter, the intensity of the main peak increases as the heat-treatment temperature of the powder increases, but there is no NBCC single phase (PDF #00-063-0337) present, and instead, there is a NdCoO₃ secondary phase. In the case of NBCC, it is considered that Nd and Co ions are first precipitated in an initial low pH region in which urea begins to decompose, and then, as the pH gradually increases due to the urea decomposition, Ba and Ca are precipitated later, which causes non-uniformity of precipitates, thereby forming the secondary phase.

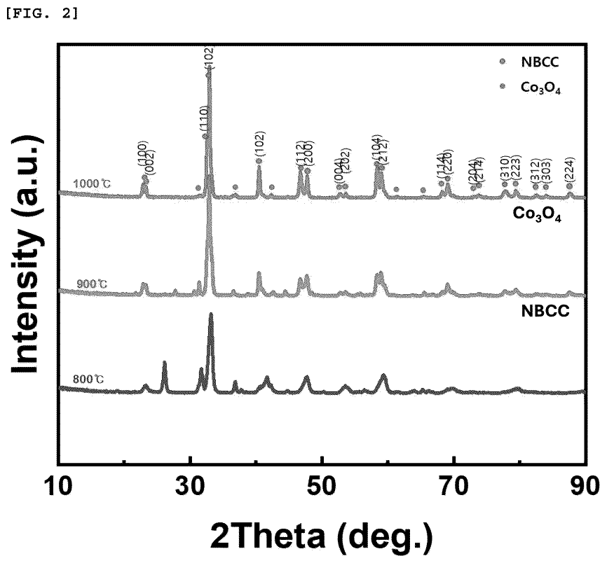

FIG. 2 shows XRD analysis results after performing heat-treatment on NBCC powder prepared using an infiltration solution containing glycine as a chelating reagent. In the case of powder prepared using the glycine-based infiltration solution, even after the heat-treatment performed at 1000° C., a Co₃O₄ secondary phase was present, and also, an NBCC phase was not completely synthesized. An NBCC element is composed of elements which are generally easy to form a complex with glycine, but there is a secondary phase present. The reason is that a uniform complex between glycine and metal atoms was not formed, and since the complex formation of glycine and cations during drying was not sufficiently achieved, some ions were precipitated as a hydroxide, thereby causing non-uniformity to form the secondary phase.

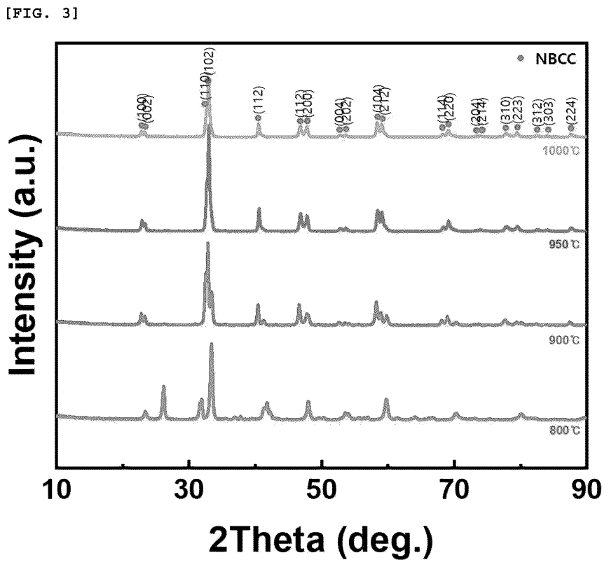

FIG. 3 shows XRD analysis results after performing heat-treatment on NBCC powder prepared using an infiltration solution prepared by adding citric acid and EDTA. It has been confirmed that NBCC powder calcined at initial 800° C. to 1000° C. has a layered double Perovskite single phase from 950° C. In general, a citric acid-based infiltration solution can yield fine-particle powders by adding an organic chelating agent, which forms complexes with metal ions and thus prevents the formation of precipitates such as hydroxides. By adding EDTA, which is used as a complex forming agent due to the wide reactivity for allowing chelating with most metal cations, it is possible to form metal ions and a complex that the citric acid has failed to form, thereby providing a more stable compound to help to synthesize a uniform material. Among the three NBCC precursor solutions, it has been confirmed that the NBCC powder, prepared with the solution in which citric acid and EDTA were added, has a single phase even at a relatively low calcination temperature of 950° C. It is determined to be due to the fact that unlike other solutions, precipitates were not generated but uniformly gelled during drying, thereby forming the powder having a single phase after calcination. Therefore, the subsequent NBCC air electrode infiltration experiment was conducted using a precursor solution prepared by adding citric acid and EDTA.

### (2) Observation Results of Microstructure of Air Electrode

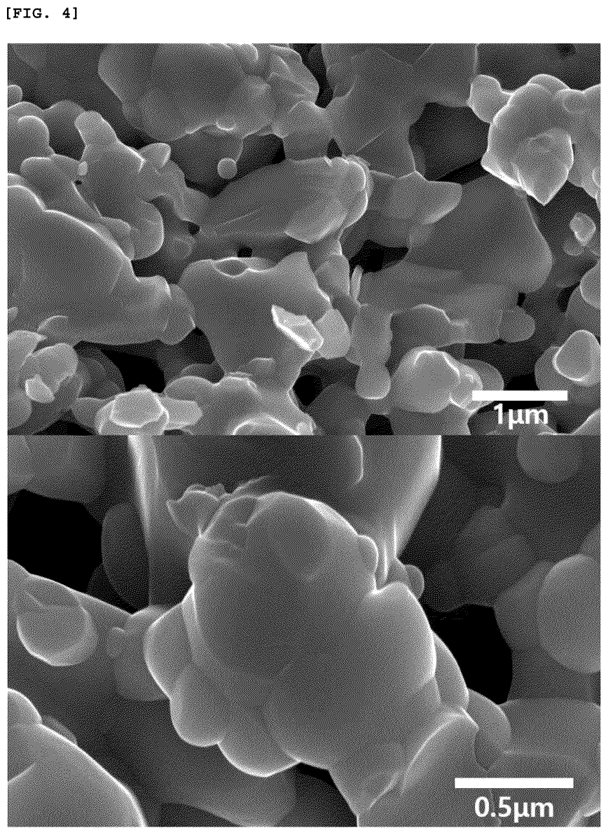

FIG. 4 shows a microstructure of an LSCF-GDC commercially available air electrode heat-treated at 1100° C. LSCF particles having an average size of about 1.5 μm and GDC particles having an average size of 68 nm are combined and form a porous structure.

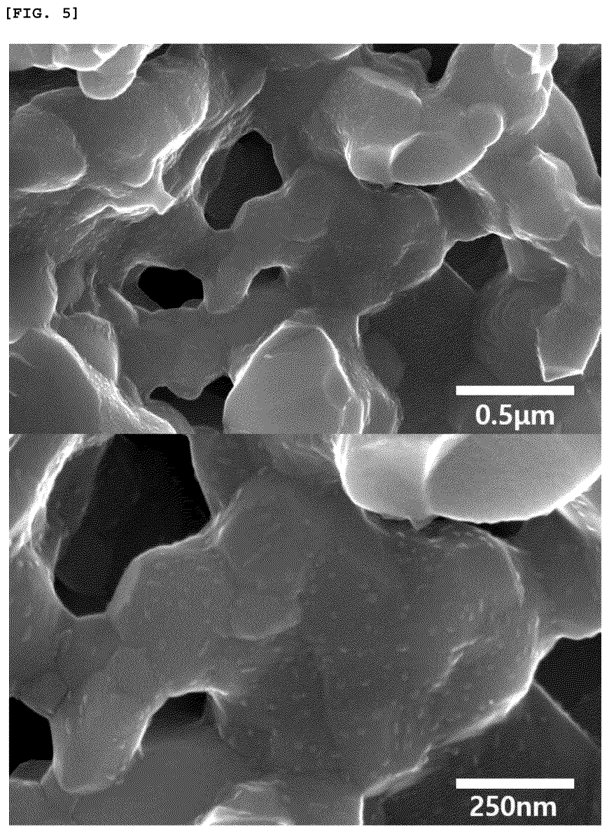

On the other hand, FIG. 5 shows the microstructure of a cross-section of an LSCF-GDC air electrode after allowing an NBCC precursor solution to infiltrate thereinto by an ultrasonic spray process and then calcining the air electrode at 950° C. for 2 hours. Nanoparticles having a size of 10 nm to 20 nm, which are presumed to be NBCC particles, are uniformly formed on the surface of the LSGC-GDC air electrode. On the other hand, TEM analysis was performed on air electrode particles infiltrated by NBCC to confirm the formation of a single phase. To this end, a TEM sample was prepared using FIB for a portion of an air electrode in which infiltration particles were formed to conduct lattice constant and composition analysis.

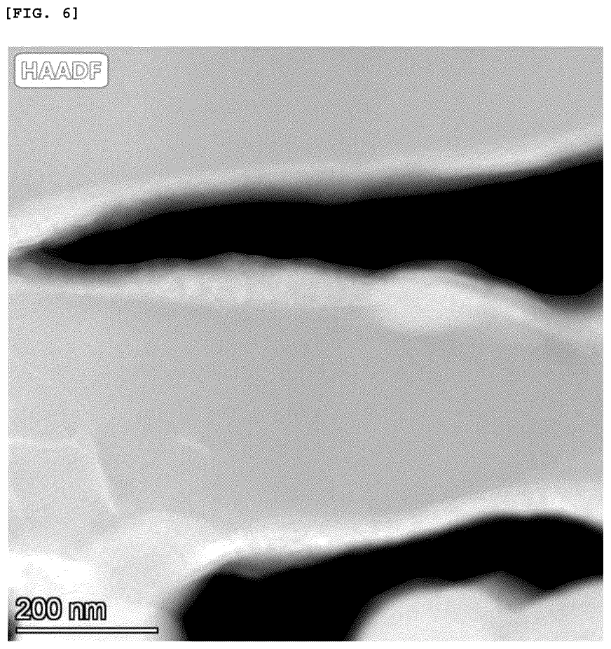

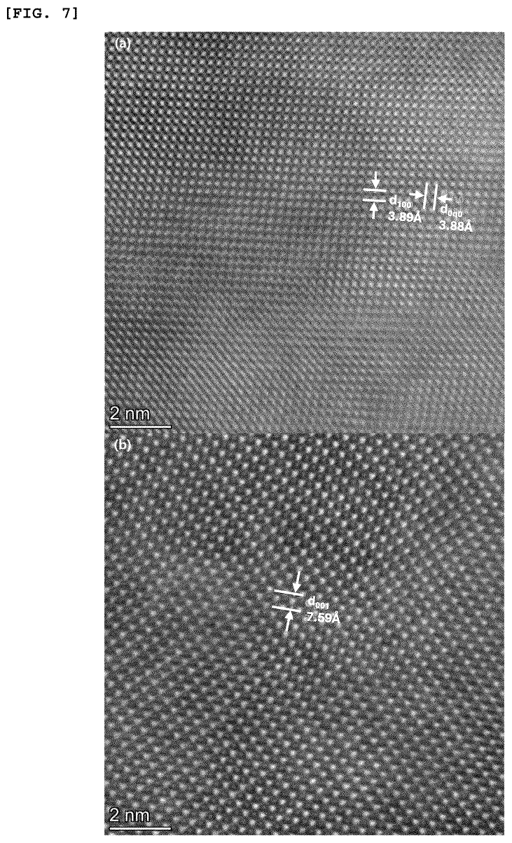

First, whether the formed infiltration particles had a structure of layered double Perovskite was confirmed through STEM, and FIG. 6 shows a microstructure of a commercially available LSCF-GDC air electrode infiltrated by NBCC. Through high-angle annular dark field scanning transmission electron microscopy (HAADF-STEM), the lattice constant was analyzed as shown in FIG. 7 (a) and FIG. 7 (b). Since the contrast in the HAADF-STEM image is brighter with a higher weight and darker with a lower weight according to the number of atoms, an Nd element appears bright and Ba/Ca elements appear dark. It can be confirmed that the lattice size of the infiltrated particles is very similar to the lattice constant (a=3.8951 Å, b=3.8831 Å, c=7.5995 Å) of NBCC reported in the preceding research result, with the distance of d100 of 3.89 Å and the distance of d010 of 3.88 Å in FIG. 7(a), and the distance of d001 of 7.59 Å in FIG. 7(b).

In addition, Table 1 shows the EDS analysis results for NBCC infiltration particles, and among detected elements, when atomic composition ratios for Nd, Ba, Ca, and Co were calculated, it was confirmed that the composition of nanoparticles formed in the air electrode was almost similar to the composition of NdBa_{0.75}Ca_{0.25}Co₂O_{5+δ}. Therefore, through STEM-EDS analysis, it was confirmed that the nano-sized infiltration particles formed on the surface of the commercially available air electrode manufactured by the ultrasonic spray process were NBCC having a single phase.

TABLE 1

| | | | Atomic | Atomic | Mass | Mass | Fit |
|---|---|---|---|---|---|---|---|
| | | | Fraction | Error | Fraction | Error | Error |
| Z | Element | Family | (%) | (% ) | (%) | (%) | (%) |
| 60 | Nd | L | 11.40 | 1.57 | 34.23 | 4.16 | 0.54 |
| 56 | Ba | L | 3.70 | 0.51 | 10.57 | 1.29 | 1.53 |
| 20 | Ca | K | 1.76 | 0.29 | 1.47 | 0.22 | 4.35 |
| 27 | Co | K | 23.60 | 3.74 | 28.96 | 4.18 | 0.45 |
| 8 | O | K | 55.66 | 4.79 | 18.54 | 1.04 | 1.03 |
| 57 | La | L | 0.00 | 0.04 | 0.00 | 0.11 | 0.00 |
| 38 | Sr | K | 1.07 | 0.20 | 1.95 | 0.34 | 10.05 |
| 26 | Fe | K | 2.25 | 0.36 | 2.62 | 0.38 | 2.89 |
| 58 | Ce | L | 0.57 | 0.10 | 1.66 | 0.26 | 9.81 |
| 64 | Gd | L | 0.00 | 0.04 | 0 | 0.12 | 0.00 |

### (3) Changes in Electrochemical Properties for Air Electrode Reaction Due to NBCC Infiltration

In order to confirm changes in electrochemical properties for an air electrode reaction due to NBCC infiltration, the impedance of half-cells applied with the LSCF-GDC air electrode and the air electrode infiltrated by NBCC was respectively measured in the range of 600° C.-750° C.

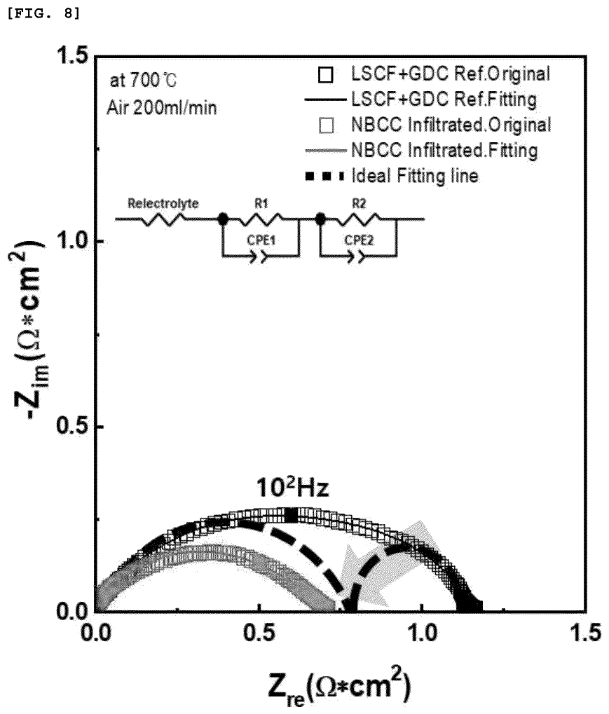

FIG. 8 shows the Nyquist plot of an LSCF-GDC air electrode infiltrated by NBCC and a commercially available LSCF-GDC air electrode, which are measured in an air atmosphere at 700° C. and a flow rate of 200 ml/min. The measured impedance result was multiplied by the area of 7×7 mm coated on the air electrode to calculate area specific resistance. The area specific resistance of the air electrode infiltrated by NBCC was reduced by about 63% compared to that of the commercially available LSCF-GDC air electrode. In addition, it was confirmed that the area specific resistance of the LSCF-GDC was also reduced by the NBCC infiltration at other measurement temperatures.

In order to evaluate the temperature dependence for air electrode reaction properties, the area specific resistance measured at 600° C. to 750° C. follows the Arrhenius equation as follows.

$$R = Ro \cdot exp ( - Ea / RT )$$

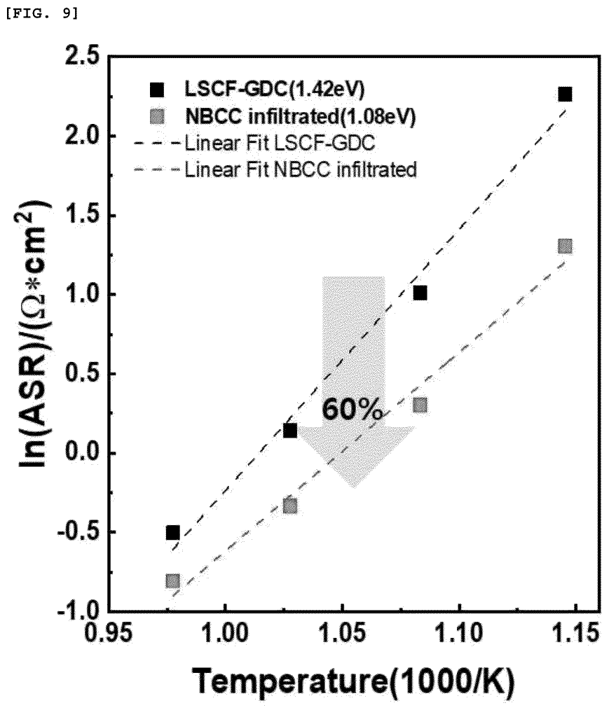

Here, the value of Ea is activation energy, which represents the activation energy required for the air electrode reaction, and the smaller the value, the less energy is required for the reaction, which means that the reaction may occur more easily. In FIG. 9, the area specific resistance of the commercially available LSCF-GDC air electrode and the area specific resistance of the LSCF-GDC air electrode infiltrated by NBCC were converted into the reciprocal relationship between a natural log and a temperature and the activation energy was calculated from the slope of the graph. The activation energy of the commercially available LSCF-GDC air electrode was 1.42 eV, whereas the activation energy of the LSCF-GDC air electrode infiltrated by NBCC was reduced to 1.08 eV. Therefore, it can be seen that the reaction properties of the commercially available air electrode were improved by the NBCC penetration.

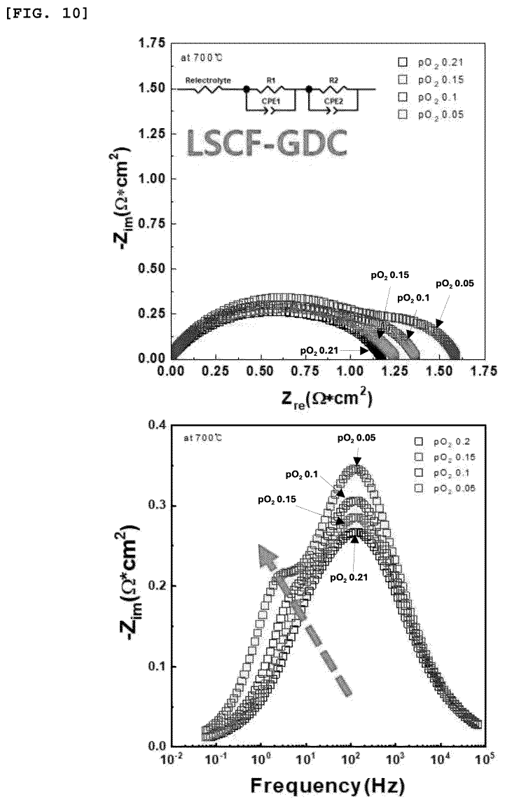

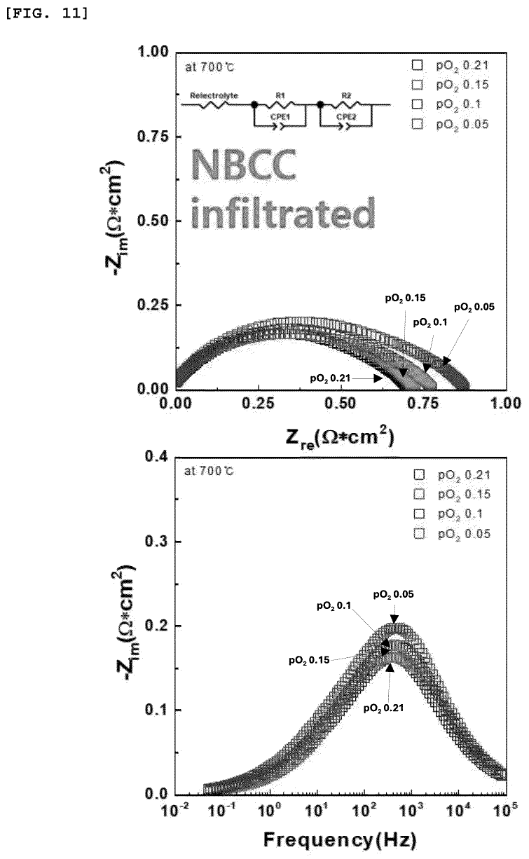

In order to confirm the performance properties of an air electrode according to an oxygen partial pressure, the impedance was measured while changing the oxygen partial pressure to 0.21, 0.15, 0.1, and 0.05 atm, and a Nyquist plot and a Bode plot were respectively shown in FIGS. 10 and 11. As the oxygen partial pressure decreased, the resistance in a low-frequency region increased for both the commercially available LSCF-GDC air electrode and the LSCF-GDC air electrode infiltrated by NBCC. This means that the low-frequency region is closely related to the oxygen partial pressure. However, the air electrode infiltrated by NBCC showed a lower resistance increase rate in the low-frequency region than the commercially available air electrode.

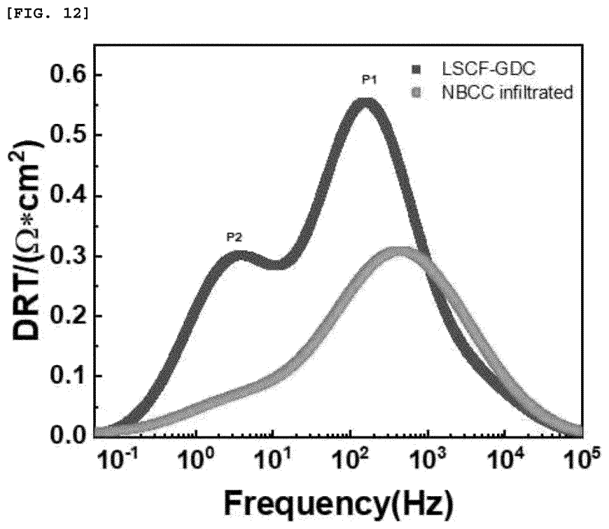

The impedance measurement results were analyzed as an equivalent circuit structure divided into R_{electrolyte}, R₁-CPE₁, and R₂-CPE₂ by converting the relationship between resistance and a frequency into a function of time by using a distribution of relaxation time (DRT) analysis method, and shown in FIG. 12. The R_{electrolyte} is the ohmic resistance of an electrolyte, which represents the resistance of the electrolyte and the contact resistance between an electrode and the electrolyte, R₁-CPE₁ is measured as the resistance of an oxygen surface exchange reaction in an air electrode in a high frequency region, and R₂-CPE₂ is known as the resistance of an oxygen reduction reaction in an air electrode in a low frequency region. Therefore, from the DRT analysis results, it can be seen that the resistance for both an oxygen surface exchange reaction and an oxygen reduction reaction of the LSCF-GDC air electrode is reduced due to the NBCC infiltration.

On the other hand, the relationship of area specific resistance according to an oxygen partial pressure follows Equation below.

$$R ∝ {Ro ( {PO}_{2} )}^{n}$$

Here, if a natural log is taken on both sides, a slope n value may be obtained from the relationship between ln(R) and ln(PO₂), which is used as a value for distinguishing an air electrode reaction step, and the air electrode undergoes the reaction in the following steps.

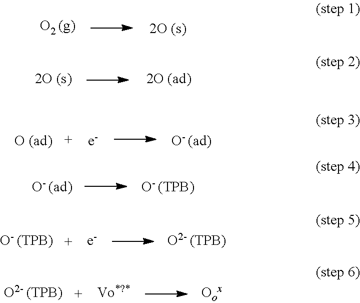

In general, a different n value corresponds to a different reaction step, and when the n has values of 1, ½, ⅜, ¼, ⅛, and 0 in the order from step 1 to step 6, it means that the steps is a rate determining step of an air electrode reaction.

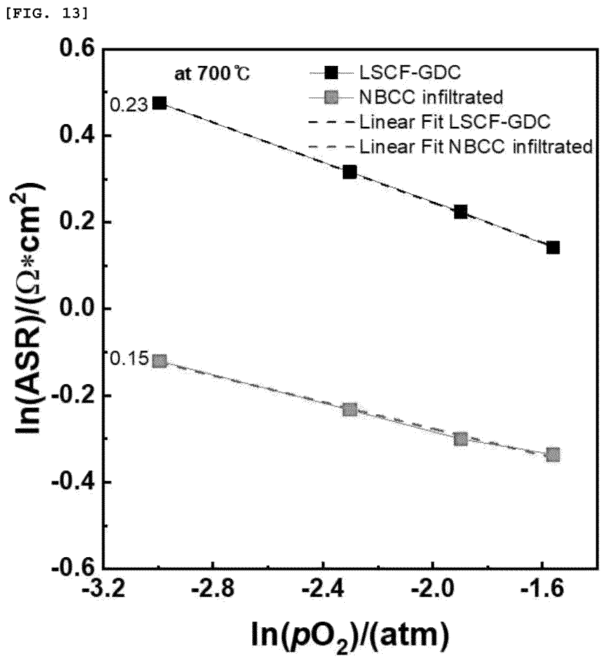

FIG. 13 shows the relationship of area specific resistance to an oxygen partial pressure taken as a natural log measured at 700° C. For the commercially available air electrode, the slope of the relationship between oxygen partial pressure and area specific resistance is 0.23, wherein the n value is close to ¼. That is, the reaction rate-determining step of the commercially available air electrode is a step (step 4) in which an adsorbed oxygen ion intermediate is diffused into a triple phase boundary region. On the other hand, the slope value of the LSCF-GDC air electrode infiltrated by NBCC corresponds to 0.15. This means that a step in which the oxygen ion intermediate moved to the triple phase boundary is reduced to stable oxygen ions at a value similar to ⅛ of step 5 is the rate-determining step. This means that as the NBCC nanoparticles are uniformly formed on the surface of the LSCF-GDC air electrode, the triple phase boundary region expands, and the rate-determining step of the reaction changes from the step in which the oxygen ion intermediate moves to the triple phase boundary region to the step in which the oxygen ion intermediate that has moved to the triple phase boundary is reduced to oxygen ions.

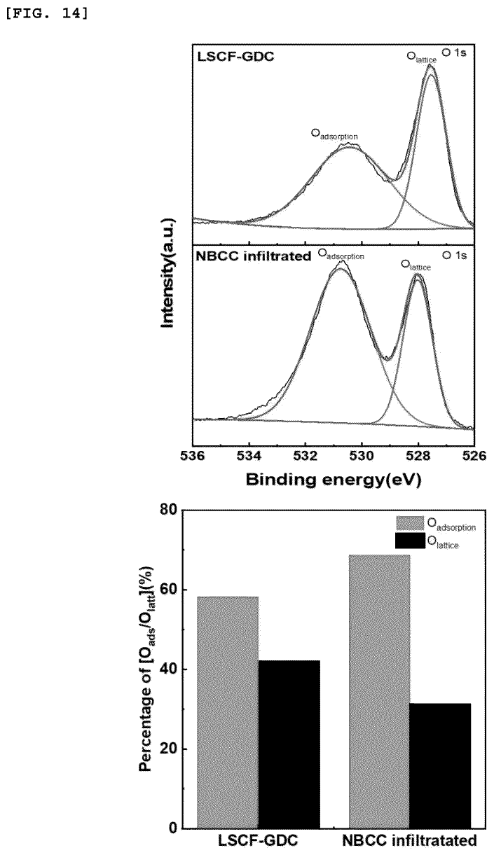

In addition, FIG. 14 shows XPS measurement results to compare the surface oxidation state between the LSCF-GDC air electrode and the air electrode infiltrated by NBCC. After the NBCC infiltration, on the surface of the air electrode, the ratio of adsorbed oxygen species to oxygen present in the lattice was higher than that of the commercially available LSCF-GDC. It is presumed to be due to the increased ratio of the oxygen species adsorbed by NBCC nanoparticles having a high surface exchange coefficient and formed on the surface of the commercially available air electrode. That is, it is determined that due to the infiltration of NBCC, the surface oxygen exchange coefficient is increased and the activation energy required for the surface exchange reaction is reduced, thereby improving the surface exchange reaction of the air electrode. Therefore, it is determined that due to the infiltration of NBCC, the surface exchange reaction of oxygen is facilitated and the triple phase boundary in which the oxygen reduction reaction mainly occurs is maximized, the adsorbed oxygen ion species may move more quickly to the triple phase boundary region, so that the rate-determining step of the commercially available air electrode has changed.

### (4) Performance Comparison of Cells Respectively Using LSCF-GDC Air Electrode and Air Electrode Infiltrated by NBCC

In the half-cell measurement experiment, the improvement effect by NBCC infiltration has confirmed, so that the performance of single cells applied with the NBCC infiltration improvement effect was measured and compared.

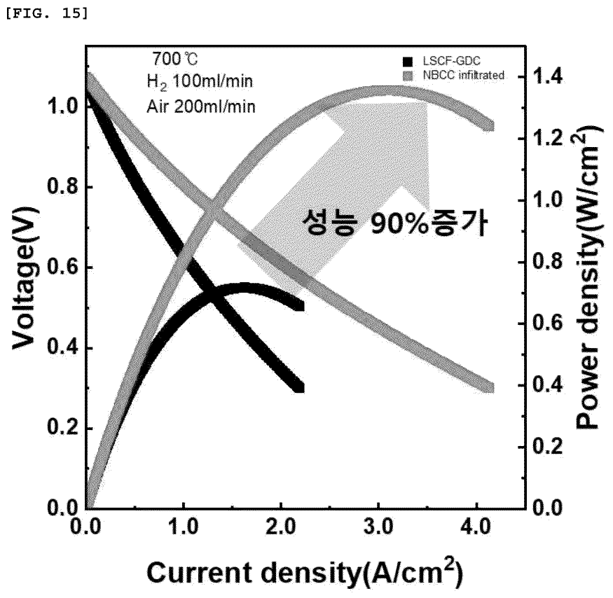

FIG. 15 shows comparison results of the performance measured at 700° C. between a single cell manufactured by coating an LSCF-GDC air electrode on the surface of an electrolyte formed on an anode support and sintering the same at 1100° C. and a single cell manufactured by allowing an NBCC precursor solution to infiltrate into the corresponding air electrode by an ultrasonic spraying process and then calcining the same at 950° C. for 2 hours.

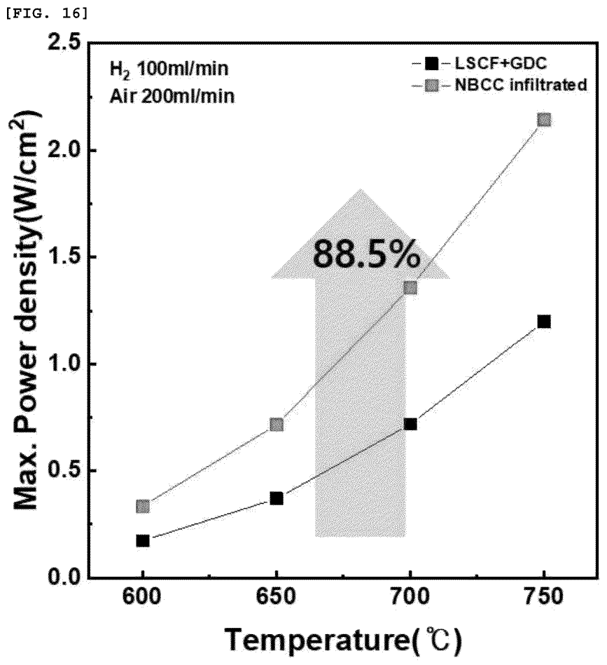

Both cells showed an open circuit voltage (OCV) of 1.1 V or higher, so that it can be seen that a dense electrolyte was formed. On the other hand, the maximum power density of the single cell applied with the air electrode infiltrated by NBCC was 1.36 W/cm², which was about 90% higher than 0.72 W/cm² of the commercially available air electrode. FIG. 16 shows comparison of the maximum power density between the two single cells according to an operating temperature. At all measured temperatures, the single cell applied with the air electrode infiltrated by NBCC showed higher performance than the single cell applied with the commercially available LSGC-GDC air electrode, and at the operating temperature of 650° C. or lower, the single cell applied with the NBCC infiltration particles showed a higher maximum power density increase rate. Therefore, it is determined that the NBCC infiltration particles significantly improved the reaction properties of the air electrode despite the decrease in operating temperature.

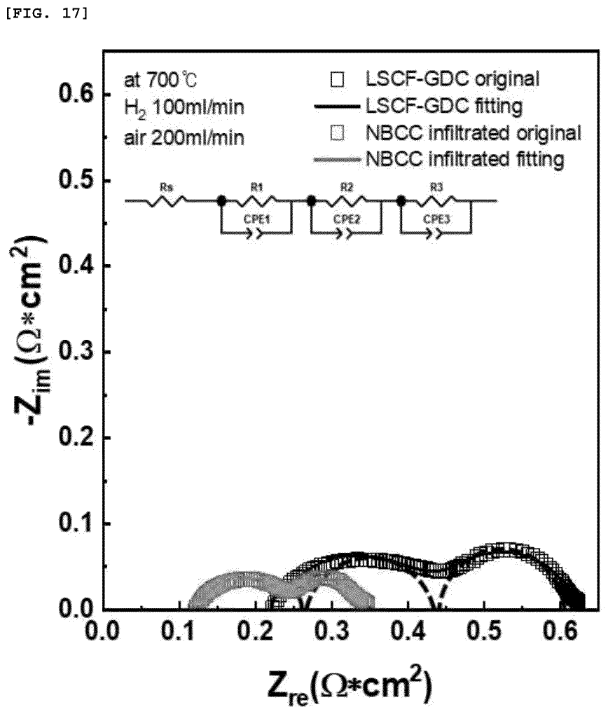

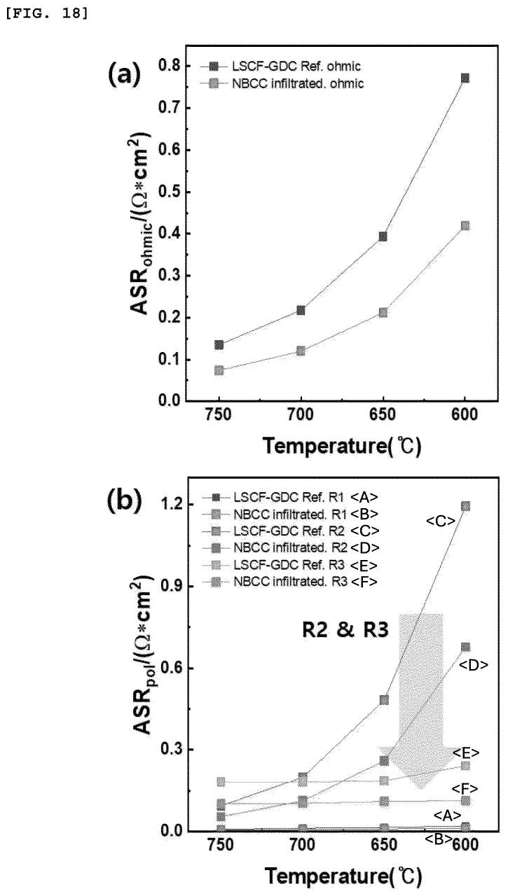

FIG. 17 shows impedance Nyquist plots of a single cell using a commercially available LSCF-GDC air electrode and a single cell applied with an air electrode infiltrated by NBCC measured at 700° C. and an open circuit voltage, and an equivalent circuit used to analyze the impedance Nyquist plots. The comparison results of the overall impedance showed that the ohmic resistance and polarization resistance of the single cell applied with the air electrode infiltrated by NBCC both decreased compared to the single cell applied with the commercially available air electrode. FIG. 18 shows comparison results of the ohmic resistance between the two single cells according to an operating temperature. Although the electrolyte thickness of the two single cells was very similar at about 7 μm, the ohmic resistance of the single cell applied with the air electrode infiltrated by NBCC decreased by about 44%. FIG. 18(b) shows analysis results obtained by dividing polarization resistance into R1, R2, and R3 according to the equivalent circuit. R1 is a high frequency region, which represents the migration of oxygen ions to an electrolyte/air electrode interface and charge transfer in an anode, R2 is a medium frequency region, which represents an oxygen exchange reaction on the surface of the air electrode, and R3 is a low frequency region, which represents the resistance to an oxygen reduction reaction in the air electrode and a gas diffusion reaction in the anode and the air electrode. Referring to the results, the resistance in the medium frequency region R2 and the resistance in the low frequency region R3, which showed the largest values among polarization resistances, were shown as main factors of polarization resistance, and the R2 and R3 resistances significantly decreased after the NBCC infiltration.

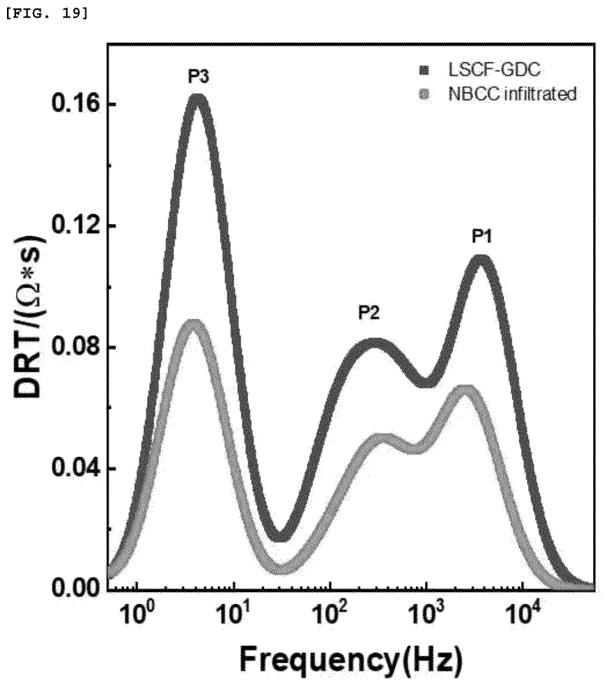

Thereafter, the impedance measurement results for the single cells were fitted using a distribution relaxation time (DRT) method, and are shown in FIG. 19. P1, P2, and P3 at which peaks appear on the graph, are steps corresponding to reactions occurring in the cell. Each reaction step indicated in the DRT corresponds to the R1, R2, and R3 described above, and the analysis results show that the resistance of the reactions corresponding to P1, P2, and P3 all decreased.

Referring to the effect of the NBCC infiltration on the air electrode through the distribution relaxation time analysis method, and the subdivision of ohmic resistance and polarization resistance, first, the reason for the decrease in ohmic resistance is that, as inferred from the decrease in resistance in the step P1 in FIG. 18, the NBCC particles are formed at the electrolyte and air electrode interface, thereby expanding the oxygen ion path to the electrolyte/air electrode interface and reducing the contact resistance, which reduces the ohmic resistance. In addition, it is determined that the surface exchange reaction of the air electrode is promoted by the NBCC particles, thereby reducing the resistance (R2) in the medium frequency region, and the oxygen reduction reaction rate is improved due to the expansion of the triple phase boundary caused by the formation of nanoparticles, so that the resistance (R3) in the low frequency region is reduced. Therefore, it has been confirmed that it is possible to improve the performance of a single cell by applying NBCC infiltration particles to a commercially available air electrode.

Next, in order to confirm long-term stability of the single cell including the anode support infiltrated by NBCC, a current was applied based on 0.8 V at 700° C. to perform long-term evaluation, and then the results were compared.

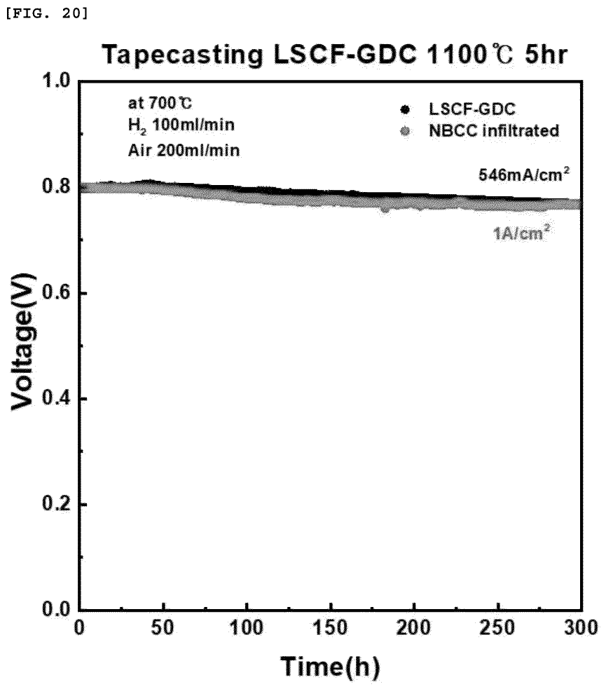

FIG. 20 shows the voltage change over time of a commercially available LSCF-GDC air electrode and an LSCF-GDC air electrode infiltrated by NBCC, and based on 0.8 V, a single cell applied with the commercially available air electrode was applied with a current density of 546 mA/cm², and a single cell applied with the air electrode infiltrated by NBCC was applied with a current density of 1 Å/cm² to perform the measurement. Referring to the voltage change after 300 hours of evaluation, the single cell applied with the commercially available air electrode showed a voltage reduction of 4.4%, and the single cell applied with the air electrode infiltrated by NBCC showed a voltage reduction of 4.1%. That is, even though a higher current density was applied to the single cell infiltrated by NBCC than to the single cell applied with the commercially available air electrode, it was confirmed that the single cell infiltrated by NBCC showed performance degradation which was similar to or slightly lower than that of the commercially available single cell, and thus, is determined to have good long-term stability, and is determined to have no problems such as accelerated deterioration or reduced durability due to the NBCC infiltration.

The features, structures, effects, and the like described in the above-described embodiments are included in at least one embodiment of the present invention, but are not necessarily limited to the one embodiment. Furthermore, the features, structures, effects, and the like illustrated in each embodiment may be combined or modified in other embodiments and implemented by those skilled in the art to which the embodiments belong. Therefore, it should be interpreted that the contents related to such a combination and modification are included in the scope of the present invention.

In addition, the above description has been made with reference to embodiments, but it is merely illustrative and does not limit the present invention. It will be understood by those skilled in the art that various modifications and applications not illustrated above are possible without departing from the inventive concept essential characteristics of the present embodiments. For example, each component specifically shown in the embodiments may be modified and implemented. Differences related to such modifications and applications should be construed as being included in the scope of the invention defined in the practice claims.

### INDUSTRIAL AVAILABILITY

The present invention forms a NdBa_{0.75}Ca_{0.25}Co₂O_{5+δ} (NBCC) layered double Perovskite oxide, which has a high surface exchange coefficient and excellent mixed conductivity, on a commercially available air electrode by an ultrasonic spray infiltration method, and thus, is capable of providing a solid oxide fuel cell having excellent maximum power density and long-term stability, and has high industrial applicability.

1. A solid oxide fuel cell having a structure in which:
an anode support;
an anode functional layer disposed in an upper portion of the anode support;
an electrolyte layer disposed in an upper portion of the anode functional layer;
a buffer layer disposed in an upper portion of the electrolyte layer;
a porous air electrode disposed in an upper portion of the buffer layer; and
a metal thin film layer disposed in an upper portion of the porous air electrode are stacked, wherein the porous air electrode contains layered double Perovskite nanoparticles.

2. The solid oxide fuel cell of claim 1, wherein the layered double Perovskite is NdBa_{0.75}Ca_{0.25}Co₂O_{5+δ}.

3. The solid oxide fuel cell of claim 1, wherein the layered double Perovskite nanoparticles have a diameter of 10 nm to 20 nm.

4. The solid oxide fuel cell of claim 1, wherein the layered double Perovskite nanoparticles are prepared by an ultrasonic spray infiltration process.

5. A method for manufacturing a solid oxide fuel cell, the method comprising:
forming an anode support, an anode functional layer, an electrolyte, and a buffer layer;
forming an air electrode on the buffer layer;
preparing an infiltration solution containing layered double Perovskite;
ultrasonic spraying the infiltration solution onto the air electrode; and
calcining the air electrode infiltrated by the infiltration solution in the ultrasonic spraying step.

6. The method of claim 5, wherein the layered double Perovskite is NdBa_{0.75}Ca_{0.25}Co₂O_{5+δ}.

7. The method of claim 5, wherein the infiltration solution comprises citric acid.

8. The method of claim 5, wherein the infiltration solution comprises citric acid and ethylenediaminetetraacetic acid (EDTA).

9. The method of claim 5, wherein the calcining step is performed at 900° C. to 1000° C.
